(19) United States
(12) Patent Application Publication
(10) Pub. No.: US 2014/0124704 A1
(43) Pub. Date: May 8, 2014

(54) BRIGHTNESS OF Y2O3:EU AT REDUCED EU WEIGHT PERCENTAGE

(71) Applicant: Global Tungsten and Powders Corporation, Towanda, PA (US)

(72) Inventor: Chung-Nin Chau, Sayre, PA (US)

(21) Appl. No.: 14/015,644

(22) Filed: Aug. 30, 2013

Related U.S. Application Data
(60) Provisional application No. 61/696,195, filed on Sep. 2, 2012.
(60) Provisional application No. 61/746,936, filed on Dec. 28, 2012.
(60) Provisional application No. 61/696,192, filed on Sep. 2, 2012.
(60) Provisional application No. 61/696,194, filed on Sep. 2, 2012.
(60) Provisional application No. 61/730,346, filed on Nov. 27, 2012.
(60) Provisional application No. 61/746,905, filed on Dec. 28, 2012.
(60) Provisional application No. 61/746,920, filed on Dec. 28, 2012.

(51) Int. Cl. C09K 11/77

(52) U.S. Cl. CPC C09K 11/7796; C09K 11/7795; C09K 11/7777
USPC 252/301.33; 252/301.4 P

(57) ABSTRACT

A yttrium europium oxide phosphor material having reduced Eu content is disclosed, together with methods for preparing and using the same.

### CROSS REFERENCE TO RELATED APPLICATIONS

The present application claims priority to U.S. Provisional Patent Applications: 61/696,192, filed on Sep. 2, 2012; 61/696,194, filed on Sep. 2, 2012; 61/696,195, filed on Sep. 2, 2012; 61/730,346, filed on Nov. 27, 2012; 61/746,905, filed on Dec. 28, 2012; 61/746,920, filed on Dec. 28, 2012; and 61/746,936, filed on Dec. 28, 2012, all of which applications are incorporated herein fully by this reference.

### BACKGROUND

1. Technical Field

The present disclosure relates to phosphor materials, together with methods for the manufacture and use thereof.

2. Technical Background

The cost of phosphor materials can be significantly influenced by the amounts of rare earth metals used in their manufacture. In particular, the amount of Europium in a red emitting Y₂O₃ phosphor, for example, Y₁₋ₓOₓ:Eu (YOE), can affect the cost of the phosphor and any lamp resulting therefrom. As global supplies of rare earth metals are limited, their cost is subject to market demands and fluctuations. With reduced rare earth production in China and increased cost of Eu₂O₃ used in the production of YOE, there is a significant interest in reducing the Eu content in YOE phosphor materials while maintaining desirable color change and brightness properties, for example, in a fluorescent lamp containing the phosphor.

Thus, there is a need to address the aforementioned problems and other shortcomings associated with traditional phosphor materials. These needs and other needs are satisfied by the compositions and methods of the present disclosure.

### SUMMARY

In accordance with the purpose(s) of the invention, as embodied and broadly described herein, this disclosure, in one aspect, relates to phosphor materials, together with methods for the manufacture and use thereof.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the relative brightness of YOE phosphor materials having varying Eu content, in accordance with various aspects of the present invention.

FIG. 2 illustrates the relative brightness of 3,000 K tri-band phosphor blends based on the addition of GdPO₄, in accordance with various aspects of the present invention.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the plastics industry to describe the relative amount of each ingredient in a composition.

As used herein the term “100 hr brightness” is intended to refer to the percentage of brightness maintained after 100 hours of lamp operation. The 100 hr brightness can be determined by dividing the light output of a lamp after 100 hours of operation by the initial light output, and multiplying the result by 100.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

It should be understood that when a reference is made to one type or composition of phosphor, other phosphors or blends of phosphors suitable for use in the invention and not contrary to the effect described can be used. Similarly, references to a rare earth phosphate, a metal phosphate, or a metal oxide are intended to refer to other rare earth phosphates, metal phosphates, or metal oxides unless such use would be inoperable or contrary to the expected effect or desired result.

As briefly described above, the present disclosure provides a yttrium europium oxide phosphor, such as, for example, a Eu doped Y₂O₃ phosphor, having a reduced content of Eu activator and having reduced brightness loss, as compared to conventional phosphor materials. In another aspect, the present disclosure provides a method for the manufacture of a yttrium europium oxide phosphor.

In one aspect, the present invention provides a method for manufacturing a red emitting yttrium europium oxide phosphor having, for example, a size of from about 2 microns to about 15 microns, at reduced Eu activator content. In another aspect, the present disclosure provides a yttrium europium oxide phosphor that exhibits a reduced loss in brightness. In another aspect, the methods described herein comprise the addition of one or more un-activated rare earth phosphate materials, such as, for example, gadolinium phosphate. In another aspect, the methods described herein comprise the addition of one or more metal phosphates. In yet another aspect, the methods described herein comprises the addition of one or more metal oxides. In another aspect, such a gadolinium phosphate can be contacted and/or mixed by a blending technique, a precipitation technique, other techniques known in the art, or a combination thereof.

In one aspect, the weight percentage of Eu in a red (Y₁₋ₓEuₓ)₂O₃ (YOE, where for example, 0.02<x<0.08) phosphor can affect the phosphor cost and subsequent optimum fluorescent lamp price; however, reducing the Eu content in a conventional YOE phosphor material can result an undesirable color change and/or decrease in brightness, when used, for example, in a fluorescent lamp.

In one aspect, the inventive phosphor has no or minimal brightness loss, even at reduced europium loading. The present disclosure also provides fluorescent lamps, including compact fluorescent lamps, comprising the inventive phosphor materials.

In one aspect, this disclosure provides a fluorescent lamp comprising the inventive phosphor material. Many styles and designs of fluorescent lamps exist, and the present invention is not intended to be limited to any particular style or design of lamp. In general, a fluorescent lamp comprises an electron source, mercury vapor, a noble gas, and a phosphor or blend of phosphor materials on the interior surface of a sealed envelope. When an electrical current is applied to the electron source, such as tungsten electrodes, electrons are emitted, exciting the noble gas molecules and colliding with mercury atoms inside the lamp (i.e., ionization). The collisions temporarily bump the electrons to a higher energy level, after which they return to their lower energy level by emitting UV radiation, for example, at 185 nm and 254 nm. The phosphor or blend of phosphor materials can absorb the UV radiation and emit visible light.

In one aspect, if the Eu content of a YOE phosphor is decreased, it can result in reduced brightness and a color shift requiring additional red emitting phosphor to provide a desirable white light. In one aspect, such a brightness drop can be associated with a drop in overall UV energy absorption at lower Eu levels. In another aspect, the lack of UV absorption and lower color x (associated with redness) can result in a need for an increased amount of red component in, for example, a red-green-blue blend lamp application.

In another aspect, a red-emitting yttrium europium oxide, (Y₁₋ₓEuₓ)₂O₃ at lower Eu content can be prepared by contacting a controlled amount of one or more non Eu containing materials, such as, for example, GdPO₄, so as to achieve one or more of: reduced loss in brightness, no or substantially no color change, and/or decreases red component usage, as compared to conventional phosphor materials.

In another aspect, a red-emitting yttrium europium oxide, (Y₁₋ₓEuₓ)₂O₃ phosphor having a reduced Eu content can be prepared by contacting a controlled amount of one or more rare earth phosphates, such as, for example, LaPO₄, GdPO₄, LuPO₄, (La₁₋ₓGdₓ)PO₄, YPO₄, or a combination thereof; one or more metal phosphates, such as, for example, BiPO₄, AlPO₄, or a combination thereof and/or one or more metal oxides, such as, for example, Al₂O₃, Y₂O₃, La₂O₃, Ta₂O₅, Nb₂O₅, or a combination thereof.

In another aspect, contacting and/or mixing can comprise direct blending and/or precipitation of (Y₁₋ₓEuₓ)₂O₃ with one or more non-fluorescent components. In one aspect, a reduced brightness drop using decreased Eu can be observed by contacting with GdPO₄ as compared to conventional phosphor materials. In other aspects, other phosphates and/or oxide compounds that did not shows this UV absorption and emission ability when added to the YOE phosphor can exhibit more rapid brightness decreases with decreasing Eu content, as compared to the inventive system.

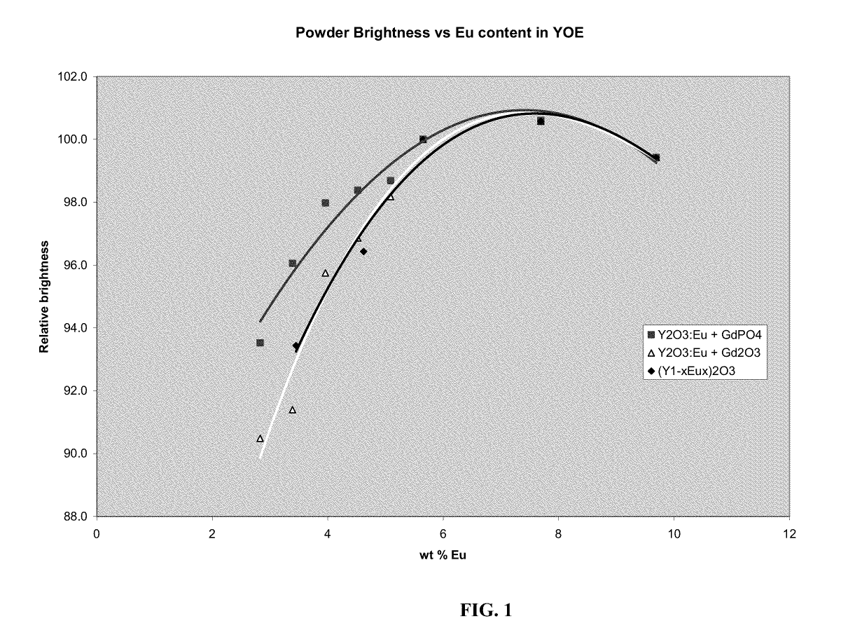

For example, FIG. 1 illustrates the reduction in brightness loss achieved for a combination of YOE and GdPO₄, as compared to YOE samples alone or in combination with Gd₂O₃.

In one aspect, a GdPO₄ having a particle size of, for example, from about 0.2 μm to about 7 μm can be contacted with a co-precipitate of can be contacted with a co-precipitate of (Y₁₋ₓEuₓ)₂O₃. In another aspect, the co-precipitate can be prepared from a solution of (Y₁₋ₓEuₓ)Cl₃, a nitrate, or a combination thereof, with oxalic acid and/or ammonium bicarbonate, followed by firing at a temperature of about 900° C. to form an oxide. The resulting material can then be contacted with a flux and fired at a temperature of at least about 1,280° C. for a period of time sufficient to form a material with a desired particle size.

In another aspect, a GdPO₄ having a particle size of, for example, from about 2 μm to about 4 μm can be suspended in a solution, for example, an aqueous solution. In another aspect, a co-precipitate of (Y₁₋ₓEuₓ)₂(C₂O₄)₃ can then be precipitated by adding a solution of (Y₁₋ₓEuₓ)Cl₃, a nitrate, or a combination thereof, and H₂C₂O₄:xH₂O to the suspension. In another aspect, the resulting precipitate can optionally be filtered, dried, and fired at a temperature of at least about 900° C. The resulting material can then be mixed with a flux and then fired at a temperature of about 1,280° C. for a period of time sufficient to form a material with a desired particle size.

In another aspect, a GdPO₄ having a particle size of, for example, from about 2 μm to about 4 μm can be suspended in a solution, for example, an aqueous solution. In another aspect, a co-precipitate of (Y₁₋ₓEuₓ)₂(CO₃)₃ can then be precipitated by adding a solution of (Y₁₋ₓEuₓ)Cl₃, a nitrate, or a combination thereof, and (NH₄)₂HCO₃:xH₂O to the suspension. In another aspect, the resulting precipitate can optionally be filtered, dried, and fired at a temperature of at least about 900° C. The resulting material can then be mixed with a flux and then fired at a temperature of about 1,280° C. for a period of time sufficient to form a material with a desired particle size.

In one aspect, the invention comprises contacting a rare earth phosphate with one or more components of a tri-band phosphor. In one aspect, a rare earth phosphate, if used, can comprise any rare earth phosphate suitable for use in the present invention. In another aspect, the rare earth phosphate, if used, can comprise LaPO₄, GdPO₄, LuPO₄, (La₁₋ₓGdₓ)PO₄, YPO₄, or a combination thereof. In another aspect, the rare earth phosphate, if used, can comprise any one or more additional rare earth phosphates not specifically recited herein, either in addition to or in lieu of any one or more rare earth phosphates listed above. In another aspect, the rare earth phosphate, if used, comprises an unactivated rare earth phosphate. In another aspect, the rare earth phosphate comprises GdPO₄. In still another aspect, the invention comprises contacting a rare earth phosphate with one or more comonents of a tri-band phosphor blend, wherein at least one or more of the components of the tri-band phosphor blend have a reduced Eu content.

In another aspect, the invention comprises contacting a metal phosphate with one or more components of a tri-band phosphor. In one aspect, a metal phosphate, if used, can comprise any metal phosphate suitable for use in the present invention. In another aspect, the metal phosphate, if used, can comprise BiPO₄, AlPO₄, or a combination thereof. In another aspect, the metal phosphate, if used, can comprise any one or more additional metal phosphates not specifically recited herein, either in addition to or in lieu of any one or more metal phosphates listed above. In another aspect, the metal phosphate, if used, comprises an unactivated metal phosphate. In still another aspect, the invention comprises contacting a metal phosphate with one or more comonents of a tri-band phosphor blend, wherein at least one or more of the components of the tri-band phosphor blend have a reduced content of Tb and/or Eu.

In another aspect, the invention comprises contacting a metal oxide with one or more components of a tri-band phosphor. In one aspect, a metal oxide, if used, can comprise any metal oxide suitable for use in the present invention. In another aspect, the metal oxide, if used, can comprise Al₂O₃, Y₂O₃, La₂O₃, Ta₂O₅, Nb₂O₅, Gd₂O₃, or a combination thereof. In another aspect, the metal oxide, if used, can comprise any one or more additional metal oxides not specifically recited herein, either in addition to or in lieu of any one or more metal oxides listed above. In one aspect, the invention can comprise Al₂O₃. In another aspect, the invention can comprise Y₂O₃. In another aspect, the invention can comprise La₂O₃. In another aspect, the invention can comprise Ta₂O₅. In another aspect, the invention can comprise Nb₂O₅. In another aspect, the invention can comprise Gd₂O₃. In still another aspect, the invention comprises contacting a metal oxide with one or more comonents of a tri-band phosphor blend, wherein at least one or more of the components of the tri-band phosphor blend have a reduced content of Tb and/or Eu. In yet other aspects, the invention can comprise a tri-band phosphor blend and one or more of a rare earth phosphate, a metal phosphate, a metal oxide, or a combination thereof.

The rare earth phosphate, metal phosphate, and/or metal oxide of the present disclosure can be contacted with a phosphor or tri-band phosphor blend in any suitable manner. In one aspect, the rare earth phosphate, metal phosphate, and/or metal oxide can be contacted with or mixed with one or more components in the tri-band phosphor blend. In another aspect, the rare earth phosphate, metal phosphate, and/or metal oxide can be mixed with the tri-band phosphor blend so as to provide a uniform or substantially uniform mixture of the materials. In another aspect, the rare earth phosphate, metal phosphate, and/or metal oxide can be applied as a separate layer that will be in contact with one or more components of a tri-band phosphor blend in a lamp assembly. In yet another aspect, the rare earth phosphate, metal phosphate, and/or metal oxide can be applied to, for example, a portion of the interior envelope of a lamp assembly as a pre-coat layer, prior to application of a tri-band layer. In still other aspects, other coating techniques and methods known in the art can be used, provided that at least a portion of the rare earth phosphate, metal phosphate, and/or metal oxide is in contact with at least a portion of the tri-band phosphor blend.

In one aspect, the addition of a rare earth phosphate, a metal phosphate, a metal oxide, or a combination thereof with a tri-band phosphor blend, can result in minimum brightness loss results over a large range of Eu reductions, as compared to a similar composition not comprising the rare earth phosphate, metal phosphate, metal oxide, or combination thereof. In another aspect, GdPO₄ is contacted with or added to a tri-band phosphor blend, such that a minimum brightness loss results over a large range of Eu reductions, as compared to a similar composition not comprising the GdPO₄.

In various aspects, the amount of rare earth phosphate, metal phosphate, metal oxide, or a combination thereof, can vary depending upon the specific phosphor materials and desired properties of the resulting product, and one of skill in the art, in possession of this disclosure, could readily select an appropriate concentration for a given phosphor or phosphor blend and application. In one aspect, a rare earth phosphate, metal phosphate, metal oxide, or a combination thereof can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %. In another aspect, a rare earth phosphate, metal phosphate, metal oxide, or a combination thereof can be present at a level of from about 0.01 wt. % to about 25 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, 15, 17, 19, 21, 23, or 25 wt. %. In another aspect, a rare earth phosphate, metal phosphate, metal oxide, or a combination thereof can be present at a level of from about 0.01 wt. % to about 15 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, or 15 wt. %. In still other aspects, a rare earth phosphate, metal phosphate, metal oxide, or a combination thereof can be present at a level of from about 1, 2, 4, 6, 8, 10, or 12 wt. %. In one aspect, GdPO₄ can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %; at a level of from about 0.01 wt. % to about 30 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, or 30 wt. %; at a level of from about 0.01 wt. % to about 25 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, or 25 wt. %; or at a level of from about 0.01 wt. % to about 20 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, or 20 wt. %, of a single phosphor, for example, LAP, or of a blend of phosphors, for example, a tri-blend phosphor composition.

In one aspect, a rare earth phosphate, metal phosphate, metal oxide, or a combination thereof can be present in a LAP phosphor at a level of up to about 60 wt. %, for example, about 0, 1, 2, 3, 4, 5, 7, 9, 12, 14, 16, 18, 20, 22, 24, 26, 28, 30, 32, 34, 36, 38, 40, 42, 44, 46, 48, 50, 52, 54, 56, 58, or 60 wt. %; up to a level of about 40 wt. %, for example, about 0, 2, 4, 6, 8, 10, 12, 14, 16, 18, 20, 22, 24, 26, 28, 30, 32, 34, 36, 38, or 40 wt. %, or up to a level of about 20 wt. %, for example, about 0, 2, 4, 6, 8, 10, 12, 14, 16, 18, or 20 wt. %. In yet another aspect, a rare earth phosphate, metal phosphate, metal oxide, or a combination thereof can be present in a LAP phosphor at a level of from about 20 wt. % to about 40 wt. %, for example, about 20, 22, 24, 26, 28, 30, 32, 34, 36, 38, or 40 wt. %. In yet another aspect, GdPO₄ can be present in a LAP phosphor at a level of from about 20 wt. % to about 40 wt. %, for example, about 20, 22, 24, 26, 28, 30, 32, 34, 36, 38, or 40 wt. %.

In one aspect, a rare earth phosphate, metal phosphate, metal oxide, or a combination thereof can be present in a YOE phosphor at a level of up to about 20 wt. %, for example, about 0, 1, 2, 3, 4, 5, 7, 9, 12, 14, 16, 18, or 20 wt. %; up to a level of about 15 wt. %, for example, about 0, 2, 4, 6, 8, 10, 12, 14, or 15 wt. %, or up to a level of about 10 wt. %, for example, about 0, 2, 4, 6, 8, or 10 wt. %. In yet another aspect, a rare earth phosphate, metal phosphate, metal oxide, or a combination thereof can be present in a YOE phosphor at a level of from about 10 wt. % to about 20 wt. %, for example, about 10, 12, 14, 16, 18, or 20 wt. %. In yet another aspect, GdPO₄ can be present in a YOE phosphor at a level of from about 10 wt. % to about 20 wt. %, for example, about 10, 12, 14, 16, 18, or 20 wt. %.

In one aspect, a rare earth phosphate, metal phosphate, metal oxide, or a combination thereof can be present in a blue emitting phosphor at a level of up to about 10 wt. %, for example, about 0, 1, 2, 3, 4, 5, 7, 9, or 10 wt. %; or up to a level of about 7 wt. %, for example, about 0, 2, 4, 6, or 7 wt. %. In yet another aspect, a rare earth phosphate, metal phosphate, metal oxide, or a combination thereof can be present in a blue emitting phosphor at a level of from about 0 wt. % to about 8 wt. %, for example, about 0.01, 0.05, 0.1, 0.5, 1, 1.5, 2, 2.5, 3, 3.5, 4, 4.5, 5, 5.5, 6, 6.5, 7, 7.5, or 8 wt. %. In yet another aspect, GdPO₄ can be present in a blue emitting phosphor at a level of from about 0 wt. % to about 8 wt. %, for example, about 0.01, 0.05, 0.1, 0.5, 1, 1.5, 2, 2.5, 3, 3.5, 4, 4.5, 5, 5.5, 6, 6.5, 7, 7.5, or 8 wt. %.

In one aspect, a rare earth phosphate, metal phosphate, metal oxide, or a combination thereof can be present in a tri-band phosphor blend at a level of up to about 60 wt. %, for example, about 0, 1, 2, 3, 4, 5, 7, 9, 12, 14, 16, 18, 20, 24, 28, 32, 36, 40, 44, 48, 52, 56, or 60 wt. %; up to a level of about 50 wt. %, for example, about 0, 2, 4, 6, 8, 10, 12, 14, 15, 20, 25, 30, 35, 40, 45, or 50 wt. %, or up to a level of about 30 wt. %, for example, about 0, 2, 4, 6, 8, 10, 12, 14, 16, 18, 20, 22, 24, 26, 28, or 30 wt. %. In yet another aspect, a rare earth phosphate, metal phosphate, metal oxide, or a combination thereof can be present in a tri-band phosphor blend at a level of from about 50 wt. % to about 60 wt. %, for example, about 50, 52, 54, 56, 58, or 60 wt. %. In yet another aspect, GdPO₄ can be present in a tri-band phosphor blend at a level of from about 10 wt. % to about 30 wt. %, for example, about 10, 12, 14, 16, 18, 20, 22, 24, 26, 28, or 30 wt. %.

Upon addition of a rare earth phosphate, metal phosphate, metal oxide, or a combination thereof, a reduction in Eu content can be achieved without any significant loss in brightness. In another aspect, the addition of a rare earth phosphate, metal phosphate, metal oxide, or a combination thereof can allow for a reduction in Eu of up to about 2 wt. %, up to about 5 wt. %, up to about 10 wt. %, up to about 15 wt. %, up to about 20 wt. %, or more, without a significant decrease in brightness.

In yet another aspect, addition of GdPO₄ to a Y₂O₃:Eu phosphor can provide beneficial results with less brightness drop at reduced Eu weight percents. In another aspect, the combination of GdPO₄ and a YOE phosphor can provide improved brightness retention and color stability, as compared to a single phase YOE phosphor, as detailed in Table 1, below. In contrast, the combination of Gd₂O₃ with a YOE phosphor can result in brightness drops greater than those observed for a single phase YOE phosphor.

TABLE 1
Combination of GdPO₄ with YOE

| Y₂O₃:Eu + GdPO₄ | | | | Y₂O₃:Eu + Gd₂O₃ | | | |
|---|---|---|---|---|---|---|---|
| wt % | | | | wt % | | | |
| Eu | % Brightness | x | y | Eu | % Brightness | x | y |
| 2.83 | 93.5 | 0.645 | 0.348 | 2.83 | 90.5 | 0.645 | 0.348 |
| 3.39 | 96.1 | 0.645 | 0.348 | 3.39 | 91.4 | 0.645 | 0.348 |
| 3.96 | 98.0 | 0.645 | 0.348 | 3.96 | 95.7 | 0.645 | 0.348 |
| 4.52 | 98.4 | 0.646 | 0.348 | 4.52 | 96.9 | 0.646 | 0.348 |
| 5.09 | 98.7 | 0.646 | 0.348 | 5.09 | 98.2 | 0.646 | 0.348 |
| 5.65 | 100.0 | 0.646 | 0.348 | 5.65 | 100.0 | 0.646 | 0.348 |

In one aspect, addition of GdPO₄ can allow a retention of at least about 95% of brightness, as compared to a convention phosphor without GdPO₄, or without a rare earth phosphate, metal phosphate, or metal oxide, at a Eu level of about 3.4 wt. % or less, for example, about 2.5, 2.75, 3, 3.1, 3.2, 3.3, or 3.4 wt. %; or a retention of at least about 98% of brightness at a Eu level of about 4 wt. % of less, for example, about 2.5, 2.75, 3, 3.25, 3.5, 3.75, 3.8, 3.9, 3.92, 3.94, 3.96, 3.98, or 4 wt. %; or a retention of about 100% of brightness at a Eu level of about 6 wt. % or less, for example, about 4, 4.25, 4.5, 4.75, 5, 5.25, 5.5, 5.75, or 6 wt. %, or at a Eu level of from about 5.75 wt. % or less, for example, about 5, 5.2, 5.25, 5.3, 5.35, 5.4, 5.45, 5.5, 5.6, or 5.65 wt. %.

In one aspect, addition of Gd₂O₃ can allow a retention of at least about 90% of brightness, as compared to a convention phosphor without Gd₂PO₃, or without a rare earth phosphate, metal phosphate, or metal oxide, at a Eu level of about 3 wt. % or less, for example, about 2.5, 2.75, 2.8, 2.85, 2.9, 2.95, or 3 wt. %; a retention of at least about 95% of brightness at a Eu level of about 4 wt. % of less, for example, about 2.5, 2.75, 3, 3.25, 3.5, 3.75, 3.8, 3.9, 3.92, 3.94, 3.96, 3.98, or 4 wt. %; or a retention of at least about 98% of brightness at a Eu level of about 5.25 wt. % of less, for example, about 3, 3.5, 3.75, 4, 4.25, 4.5, 4.75, 4.8, 4.9, 4.95, 5, 5.05, 5.1, 5.15, 5.2, or 5.25 wt. %; or a retention of about 100% of brightness at a Eu level of about 6 wt. % or less, for example, about 4, 4.25, 4.5, 4.75, 5, 5.25, 5.5, 5.75, or 6 wt. %, or at a Eu level of from about 5.75 wt. % or less, for example, about 5, 5.2, 5.25, 5.3, 5.35, 5.4, 5.45, 5.5, 5.6, or 5.65 wt. %.

In other aspects, the particle size of all or a portion of a phosphor material or a blend of phosphor materials, for example, in a tri-band blend comprising a rare earth phosphate, metal phosphate, metal oxide, or a combination thereof, can vary, and the present invention is not intended to be limited to any particular particle size. In another aspect, all or a portion of the phosphor materials can exhibit an average particle size of from about 0.5 μm to about 30 μm, for example, about 0.5, 1, 1.5, 2, 2.5, 3, 4, 5, 7, 9, 11, 13, 15, 17, 19, 21, 23, 25, 27, 29, or 30 μm; from about 2 μm to about 16 μm, for example, about 2, 3, 4, 5, 6, 7, 8, 9, 10, 11, 12, 13, 14, 15, or 16 μm; from about 2 μm to about 8 μm, for example, about 2, 2.5, 3, 3.5, 4, 4.5, 5, 5.5, 6, 6.5, 7, 7.5, or 8 μm; or from about 4 μm to about 10 μm, for example, about 4, 4.5, 5, 5.5, 6, 6.5, 7, 7.5, 8, 8.5, 9, 9.5, or 10 μm. In a specific aspect, all or a portion of a phosphor material, such as, for example, a tri-band blend of phosphor materials exhibits an average particle size of about 5 μm.

In another aspect, the rare earth phosphate, metal phosphate, metal oxide, or a combination thereof, can comprise a particle size larger than all or a portion of the phosphor material or blend of phosphor materials. In one aspect, at least a portion of the rare earth phosphate, metal phosphate, metal oxide, or a combination thereof, such as, for example, GdPO₄, can exhibit an average particle size of from about 100% to about 150%, for example, about 100, 102, 104, 106, 108, 110, 112, 114, 116, 118, 120, 125, 130, 135, 140, 145, or 150% of the average particle size of at least one of the phosphor materials. In another aspect, at least a portion of the rare earth phosphate, metal phosphate, metal oxide, or a combination thereof, such as, for example, GdPO₄, can exhibit an average particle size of from about 100% to about 125%, for example, about 100, 102, 104, 106, 108, 110, 112, 114, 116, 118, 120, or 125% of the average particle size of at least one of the phosphor materials. In a specific aspect, a tri-band phosphor blend can comprise an average particle size of about 5 μm, and the rare earth phosphate, metal phosphate, metal oxide, or a combination thereof, such as, for example, GdPO4, can exhibit an average particle size of from about 5 μm to about 7 μm, for example, about 5, 5.5, 6, 6.5, or 7 μm; or from about 5 μm to about 6 μm, for example, about 5, 5.2, 5.4, 5.6, 5.8, or 6 μm; or from about 5.2 μm to about 5.7 μm, for example, about 5.2, 5.3, 5.4, 5.5, 5.6, or 5.7 μm. In a specific aspect, a phosphor material, such as, for example, a tri-band blend of phosphors exhibits an average particle size of about 5 μm and the rare earth phosphate, metal phosphate, metal oxide, or a combination thereof exhibits an average particle size of about 5.5 μm.

In another aspect, one or more non-fluorescent materials can be contacted with a phosphor or phosphor blend so as to provide improved brightness for a phosphor having a reduced activator content. In various aspects, the one or more non-fluorescent materials can be contacted with a phosphor or phosphor blend, or with any other component that can be subsequently contacted therewith, by blending, firing, or coating.

In one aspect, a phosphor host lattice, such as, for example, those commonly used as host lattice materials, can be utilized as a component in a phosphor or phosphor blend. In another aspect, such host materials can be non-UV absorptive, so as not to compete with the phosphor or phosphor blend for UV energy. In various aspects, such components can comprise a phosphate material, a halophosphate material, a silicate material, an aluminate material, a borate material, an oxide material, a vanadate material, a gallate material, a germinate material, or a combination thereof. In other aspects, a phosphor or phosphor blend can specifically exclude any one or more of the components recited herein.

In other aspects, the inventive phosphor material can be utilized in a lamp or lamp assembly, such as, for example, a fluorescent lamp, a compact fluorescent lamp, or a combination thereof. In one aspect, this disclosure provides a fluorescent lamp comprising the inventive phosphor material. Many styles and designs of fluorescent lamps exist, and the present invention is not intended to be limited to any particular style or design of lamp. In general, a fluorescent lamp comprises an electron source, mercury vapor, a noble gas, and a phosphor or blend of phosphor materials on the interior surface of a sealed envelope. In a conventional fluorescent lamp, when an electrical current is applied to the electron source, such as tungsten electrodes, electrons are emitted, exciting noble gas molecules and colliding with mercury atoms inside the lamp (i.e., ionization). The collisions temporarily bump the electrons to a higher energy level, after which they return to their lower energy level by emitting UV radiation, for example, at 185 nm and 254 nm. The phosphor or blend of phosphor materials can absorb the UV radiation and emit visible light. In another aspect, the phosphors of the present invention can be used in a compact fluorescent lamp, wherein the fluorescent envelope is attached to a ballast, and wherein the lamp assembly has a screw base for use in conventional light fixtures.

In various aspects, many fluorescent lamps utilize a tri-band phosphor layer that comprises one or more red emission phosphors, one or more green emission phosphors, and one or more blue emission phosphors. While specific phosphors and phosphor combinations are specifically recited herein, the invention is intended to include any suitable phosphor or combination of phosphors in combination with a rare earth oxide, as described in the detailed description, claims, examples, and figures that follow. A blend of red, green, and blue emitting phosphor materials, or a layer comprising red, green, and blue emitting phosphors can be used to generate white light having a color temperature of from about 2,700K to about 6,500K. In another aspect, a tri-band blend of phosphors can also contain a fourth component, such as for example, a blue/green emitting component. Blue/green emitting components can, in various aspects, provide lamps having high Ra values.

In other aspects, a phosphor blend can also comprise a deep red emitting component, such as, for example, a Mn(IV) germinate phosphor material.

In one aspect, a red emission phosphor can comprise a Europium doped phosphor, such as, for example, Y₂O₃:Eu (YOE), Gd₂O₃:Eu (GOE), or a combination thereof. In such an aspect, the red emission phosphor can exhibit a Eu³⁺ emission spectrum. In another aspect, a green emission phosphor can comprise a Terbium doped phosphor, such as, for example, (LaCeTb)PO₄ (LAP), (CeTb)MgAl₁₁O₁₉ (CAT), or (GdCeTb)MgB₅O₁₀ (CBT), or a combination thereof. In such an aspect, the green emission phosphor can exhibit a Tb³⁺ emission spectrum. In yet another aspect, a blue emission phosphor can comprise a Europium doped phosphor, such as, for example, (BaEu)MgAl₁₀O₁₇ (BAM), (SrCaEu)₅(PO₄)₃Cl (SCAP), or a combination thereof. In such an aspect, the blue emission phosphor can exhibit a Eu²⁺ emission spectrum.

In another aspect, a blue/green emitting component can be present and can comprise Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

In one aspect, any one or more of the components described herein can be provided in a pure or substantially pure form. As used herein, the terms “pure” and “substantially pure” are intended to refer to components that do not comprise large quantities of impurities. In various aspects, substantially pure can refer to components having less than about 500 ppm, less than about 250 ppm, less than about 100 ppm, less than about 75 ppm, less than about 50 ppm, less than about 25 ppm, or less than about 10 ppm of impurities or other contaminants. It should be noted that, in some cases, an element, compound, or species can be present as intended in one component, but can be considered an impurity or contaminant if present in another component, for example, if entrained in the matrix of one component. In another aspect, the presence of impurities, such as, for example, Ce, Tb, and/or Eu, can result in undesirable UV absorption of GdPO₄. For example, in one aspect, an increase in Ce concentration can result in UV absorption around about 254 nm. Such absorption can, in various aspects, result in phosphor blends having reduced brightness. Thus, in one aspect, the level of Ce present is less than about 50 ppm, for example, about 50, 48, 46, 44, 42, 40, 38, 36, 34, 32, 30, 28, 26, 24, 22, 20, 18, 16, 14, 12, 10, 8, 6, 4, 2 ppm, or less. In another aspect, the level of Ce present is less than about 10 ppm, for example, about 10, 9, 8, 7, 6, 5, 4, 3, 2, or 1 ppm, or less.

In yet another aspect, the presence of lattice defects in a rare earth phosphate, metal oxide, or a combination thereof, can result in a phosphor blend having a reduced brightness. For example, lattice defects created by non-stoichiometric synthesis of a rare earth phosphate can provide reduced brightness. In a specific aspect, a rare earth phosphate produced by direct firing of Gd₂O₃ with DAP at less than about 1 phosphate ratio can result in a GdPO₄ having absorption in the UV and/or visible region, leading to reduced brightness when incorporated in a phosphor blend.

The present invention can be described in various non-limiting aspects, such as the following.

Aspect 1: A method for preparing a phosphor material, the method comprising contacting GdPO₄ with a co-precipitate of (Y₁₋ₓEuₓ)₂O₃, (Y₁₋ₓEuₓ)₂(C₂O₄)₃, (Y₁₋ₓEuₓ)₂(CO₃)₃, or a combination thereof.

Aspect 2: The method of aspect 1, wherein GdPO₄ is contacted with (Y₁₋ₓEuₓ)₂O₃.

Aspect 3: The method of aspect 2, wherein the (Y₁₋ₓEuₓ)₂O₃ is prepared from a solution of (Y₁₋ₓEuₓ)Cl₃, a nitrate, or a combination thereof, with oxalic acid, ammonium bicarbonate, or a combination thereof.

Aspect 4: The method of aspect 1, wherein GdPO₄ is contacted with (Y₁₋ₓEuₓ)₂(C₂O₄)₃.

Aspect 5: The method of aspect 4, wherein the (Y₁₋ₓEuₓ)₂(C₂O₄)₃ is prepared from a solution of (Y₁₋ₓEuₓ)Cl₃, a nitrate, or a combination thereof, with H₂C₂O₄:xH₂O.

Aspect 6: The method of aspect 1, wherein GdPO₄ is contacted with (Y₁₋ₓEuₓ)₂(CO₃)₃.

Aspect 7: The method of aspect 6, wherein the (Y₁₋ₓEuₓ)₂(CO₃)₃ is prepared from a solution of (Y₁₋ₓEuₓ)Cl₃, a nitrate, or a combination thereof, with (NH₄)₂HCO₃:xH₂O.

Aspect 8: The method of any preceding aspect, wherein the resulting phosphor material is fired at a temperature of at least about 900° C.

Aspect 9: The method of aspect 9, prior to firing, the resulting phosphor material is optionally filtered and/or dried.

Aspect 10: The method of any preceding aspect, wherein after firing at a temperature of about 900° C., the resulting phosphor material can be contacted with a flux and fired at a temperature of about 1,280° C. for a period of time sufficient to produce a composition having a desired particle size.

Aspect 11: The method of aspect 1, wherein the GdPO₄ has an average particle size of from about 0.2 μm to about 7 μm.

Aspect 12: The method of aspect 1, wherein the GdPO₄ has an average particle size of from about 2 μm to about 4 μm.

Aspect 13: A phosphor material prepared by any of the methods of aspects 1-12.

Aspect 14: A YOE phosphor material having a reduced Eu content, while maintaining a comparable brightness loss to a convention YOE phosphor not having a reduced Eu content.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. YOE Phosphor Materials

In a first example, samples of YOE phosphor materials were prepared as detailed in Table 2, below, having varying Eu content. For each sample, lamps were prepared using a 3,500K tri-band phosphor blend comprising YOE, LAP, and BAM phosphors. As detailed in Table 2, reduction in brightness and a shift in color coordinates occurred for the samples having reduced Eu content.

TABLE 2
Phosphor materials having reduced Eu content

| (Y₁₋ₓEuₓ)₂O₃ | Powder | | | | 3500K lamp YOE/LAP/BAM Blend | |
|---|---|---|---|---|---|---|
| Eu = x | % Brightness | color x | color y | 1-r 254 nm | % 100 Hr Brightness | wt % YOE in blend |
| 0.026 | 93.4 | 0.640 | 0.352 | 0.799 | 99.2 | 57.6 |
| 0.035 | 96.4 | 0.643 | 0.350 | 0.849 | 99.5 | 54.7 |
| 0.043 | 100.0 | 0.646 | 0.348 | 0.860 | 99.3 | 52.8 |
| 0.059 | 100.6 | 0.649 | 0.346 | 0.885 | 99.7 | 47.4 |
| 0.075 | 99.4 | 0.651 | 0.345 | 0.908 | 100.0 | 44.5 |

2. 3,000K Tri-Band Phosphor Blend Lamp with GdPO4

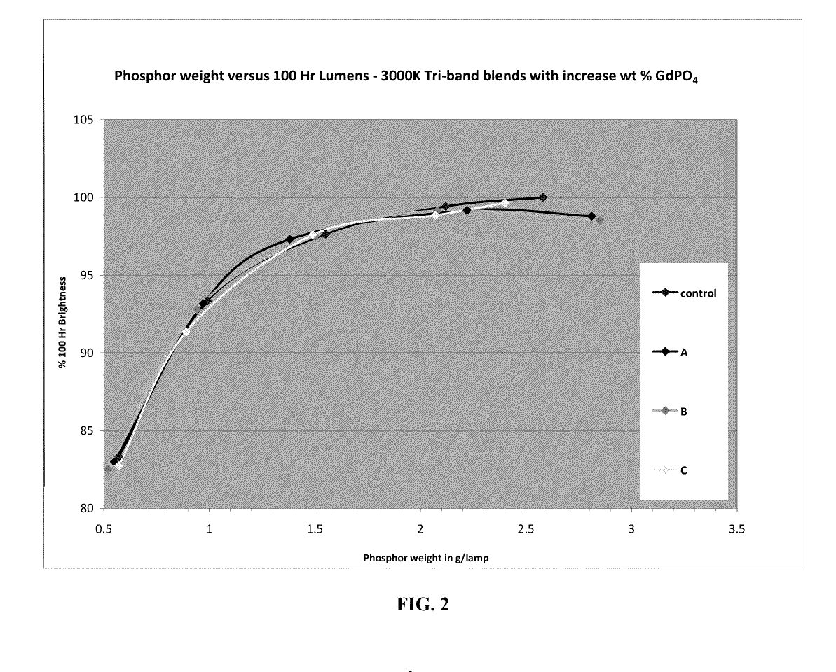

In a second example, a 3,000K tri-band phosphor blend was prepared using a red emitting phosphor, (Y_{0.957}Eu_{0.043})₂O₃, a green emitting phosphor, (La_{0.45}Ce_{0.42}Tb_{0.13})PO₄, and a blue emitting phosphor, (Ba_{0.948}Eu_{0.052})MgAl₁₀O₁₇. Four blends including the control were prepared, as detailed in Table 3, below, wherein the particle size of the phosphor materials and the GdPO₄ was about 5 microns. FIG. 2 illustrates the relative brightness of each of the samples listed in Table 3, as the amount of phosphor material in the lamp is varied.

TABLE 3
3,000K Tri-Band Phospohr Blends

| | | | % Eu | % YOE in |
|---|---|---|---|---|
| Blend | Wt % GdPO₄ | % Eu | Reduction | Blend |
| Control | 0 | 3.19 | 0 | 52.3 |
| A | 4.21 | 3.05 | 4.61 | 49.7 |
| B | 8.84 | 2.94 | 8.02 | 48.0 |
| C | 13.68 | 2.86 | 10.45 | 46.7 |

As illustrated above, no significant loss in lamp brightness was observed for samples with added GdPO₄, such that Eu content can be reduced. In addition to maintaining brightness, no increase in red component weight percentage in the blend was needed as the Eu content in the blend decreases. In fact, a decreased red component usage was observed as the overall Eu content in the blend decreased. This is in contrast to conventional phosphor materials. In another aspect, it is possible that even higher weight percentages of GdPO₄ can be used, for example, a 15 to 25% GdPO₄ addition or more, and depending on the lamp cost and lumens requirement, even a 50% GdPO₄ or higher addition can be possible.

It should be noted that while this experiment was done with YOE-LAP-BAM at a specific composition, particle size, and blend color temperature, other compositions and particle sizes, for example, from about 2 to about 15 microns, can exhibit similar behavior. For example, YOE can be (Y₁₋ₓEuₓ)₂O₃ where 0.02<x<0.1, (La_{1-x-y}CeₓTb_{y})PO₄ where 0.2<x<0.5, 0.05<y<0.2, and (Ba₁₋ₓEuₓ)MgAl₁₀O₁₇ where 0.015<x<0.08. In another aspect, tri-band phosphor blends having other color temperatures (2700K to 7500K) can be prepared by utilizing varying red:green:blue ratios, and any such combinations can be expected to provide similar effects.

In other aspects, other red phosphors such as GOE, other green phosphors such as CAT or CBT, and other blue phosphors such as SCAP will perform similarly with similar configurations.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for preparing a phosphor material, the method comprising contacting GdPO₄ with a co-precipitate of (Y₁₋ₓEuₓ)₂O₃, (Y₁₋ₓEuₓ)₂(C₂O₄)₃, (Y₁₋ₓEuₓ)₂(CO₃)₃, or a combination thereof.

2. The method of claim 1, wherein GdPO₄ is contacted with (Y₁₋ₓEuₓ)₂O₃.

3. The method of claim 2, wherein the (Y₁₋ₓEuₓ)₂O₃ is prepared from a solution of (Y₁₋ₓEuₓ)Cl₃, a nitrate, or a combination thereof, with oxalic acid, ammonium bicarbonate, or a combination thereof.

4. The method of claim 1, wherein GdPO₄ is contacted with (Y₁₋ₓEuₓ)₂(C₂O₄)₃.

5. The method of claim 4, wherein the (Y₁₋ₓEuₓ)₂(C₂O₄)₃ is prepared from a solution of (Y₁₋ₓEuₓ)Cl₃, a nitrate, or a combination thereof, with H₂C₂O₄:xH₂O.

6. The method of claim 1, wherein GdPO₄ is contacted with (Y₁₋ₓEuₓ)₂(CO₃)₃.

7. The method of claim 6, wherein the (Y₁₋ₓEuₓ)₂(CO₃)₃ is prepared from a solution of (Y₁₋ₓEuₓ)Cl₃, a nitrate, or a combination thereof, with (NH₄)₂HCO₃:xH₂O.

8. The method of claim 1, wherein the resulting phosphor material is fired at a temperature of at least about 900° C.

9. The method of claim 8, prior to firing, the resulting phosphor material is optionally filtered and/or dried.

10. The method of claim 8, wherein after firing at a temperature of about 900° C., the resulting phosphor material can be contacted with a flux and fired at a temperature of about 1,280° C. for a period of time sufficient to produce a composition having a desired particle size.

11. The method of claim 1, wherein the GdPO₄ has an average particle size of from about 0.2 μm to about 7 μm.

12. The method of claim 1, wherein the GdPO₄ has an average particle size of from about 2 μm to about 4 μm.

13. A phosphor material prepared by the methods of claim 1.

14. A YOE phosphor material having a reduced Eu content, while maintaining a comparable brightness loss to a convention YOE phosphor not having a reduced Eu content

15. The YOE phosphor of claim 14, having at least about 5 wt. % less Eu than a conventional YOE phosphor not comprising or contacted with a rare earth phosphate, a metal phosphate, a metal oxide, or a combination thereof.

16. The YOE phosphor of claim 14, having at least about 10 wt. % less Eu than a conventional YOE phosphor not comprising or contacted with a rare earth phosphate, a metal phosphate, a metal oxide, or a combination thereof.

17. The YOE phosphor of claim 14, having at least about 15 wt. % less Eu than a conventional YOE phosphor not comprising or contacted with a rare earth phosphate, a metal phosphate, a metal oxide, or a combination thereof.

18. The YOE phosphor of claim 14, retaining at least about 96% brightness with a Eu content of about 3.5 wt. % or less, as compared to a conventional phosphor not comprising or contacted with a rare earth phosphate, a metal phosphate, a metal oxide, or a combination thereof.

19. The YOE phosphor of claim 14, retaining at least about 98% brightness with a Eu content of about 4 wt. % or less, as compared to a conventional phosphor not comprising or contacted with a rare earth phosphate, a metal phosphate, a metal oxide, or a combination thereof.

20. The YOE phosphor of claim 14, retaining at least about 100% brightness with a Eu content of about 5.75 wt. % or less, as compared to a conventional phosphor not comprising or contacted with a rare earth phosphate, a metal phosphate, a metal oxide, or a combination thereof.
